(19) United States
(12) Patent Application Publication
(10) Pub. No.: US 2024/0332755 A1
(43) Pub. Date: Oct. 3, 2024

(54) BATTERY MODULE

(71) Applicant: HONDA MOTOR CO., LTD., Tokyo (JP)

(72) Inventors: Keiichiro OKA, Saitama (JP); Takahiro TAMURA, Saitama (JP)

(21) Appl. No.: 18/586,552

(22) Filed: Feb. 26, 2024

(30) Foreign Application Priority Data
Mar. 30, 2023 (CN) 202310326178.4

(51) Int. Cl. H01M 50/54; H01M 50/178; H01M 50/204; H01M 50/289; H01M 50/548

(52) U.S. Cl. CPC H01M 50/54; H01M 50/178; H01M 50/289; H01M 50/548; H01M 50/204

(57) ABSTRACT

The present invention provides a battery module including a battery cell stack in which a plurality of battery cells are stacked, each of the plurality of battery cells including an electrode stack that is packaged by a packaging material, and having a positive electrode tab lead and a negative electrode tab lead that are protruding from the packaging material, the negative electrode tab lead protruding in a reverse direction to the positive electrode tab lead. Adjacent battery cells are disposed such that the positive electrode tab leads are close to each other, the negative electrode tab leads are close to each other, or the positive electrode tab lead of one adjacent battery cell is close to the negative electrode tab lead of the other adjacent battery cell.

This application is based on and claims the benefit of priority from Chinese Patent Application No. CN202310326178.4, filed on 30 Mar. 2023, the content of which is incorporated herein by reference.

### BACKGROUND OF THE INVENTION

### Field of the Invention

The present invention pertains to a battery module.

### Related Art

In recent years, research and development pertaining to battery modules that contribute to improving energy efficiency has been carried out in order to be able to ensure access to sustainable and advanced energy that is affordable and can be trusted by many people.

A plurality of battery cells are stacked in a battery module. In a battery cell, for example, an electrode stack is packaged in a packaging material and has a positive electrode tab lead and a negative electrode tab lead that are protruding from the packaging material. In addition, the electrode stack results from stacking a plurality of positive electrodes and a plurality of negative electrodes with an electrolyte interposed therebetween. The plurality of positive electrode are connected to the positive electrode tab lead, and the plurality of negative electrodes are connected to the negative electrode tab lead. Here, because a battery cell expands and contracts in conjunction with charging and discharging, a cushion material is installed between battery cells and between a battery cell and an end plate.

For example, Japanese Unexamined Patent Application, Publication No. 2020-77500 discloses a battery pack in which gap adjustment units are intermittently disposed between all-solid-state battery cells. Here, in a gap adjustment unit, an elastic body is disposed between a pair of plates.
Patent Document 1: Japanese Unexamined Patent Application, Publication No. 2020-77500

### SUMMARY OF THE INVENTION

However, the battery pack disclosed in Japanese Unexamined Patent Application, Publication No. 2020-77500 has a decreased energy density because the gap adjustment units are disposed between the all-solid-state battery cells.

For example, consideration can be given to not installing cushion material between battery cells, but when battery cells expand and contract accompanying charging and discharging of the battery cells, there is the risk that the gap between adjacent tab leads will change. As a result, there is decreased reliability of connection sections between tab leads of adjacent battery cells and joint sections between tab leads and packaging material.

One object of the present invention is to provide a battery module that enables improved energy density while also improving the reliability of connection sections between tab leads of adjacent battery cells and joint sections between tab leads and packaging material even if the battery cells expand and contract accompanying charging and discharging of the battery cells.

(1) A battery module includes a battery cell stack in which a plurality of battery cells are stacked, each of the plurality of battery cells including an electrode stack that is packaged by a packaging material, and having a positive electrode tab lead and a negative electrode tab lead that are protruding from the packaging material, the negative electrode tab lead protruding in a reverse direction to the positive electrode tab lead, the electrode stack including a plurality of positive electrodes and a plurality of negative electrodes stacked therein with an electrolyte respectively interposed between the plurality of positive electrodes and the plurality of negative electrodes. The positive electrode tab lead is disposed at one end of the battery cell in a stacking direction of the battery cell and is connected to the plurality of positive electrodes, the negative electrode tab lead is disposed at the other end of the battery cell in the stacking direction of the battery cell and is connected to the plurality of negative electrodes, and adjacent battery cells are disposed such that the positive electrode tab leads are close to each other, the negative electrode tab leads are close to each other, or the positive electrode tab lead of one adjacent battery cell is close to the negative electrode tab lead of the other adjacent battery cell.

(2) The battery module according to (1), in which the packaging material is a laminate film, and a sealed section is formed at least at one outer circumferential section of the packaging material on a side where neither of the positive electrode tab lead and the negative electrode tab lead is protruding, and
a surface of the sealed section has an inclined section that is substantially parallel to a plane formed by a position where the positive electrode tab lead protrudes from the laminate film and a position where the negative electrode tab lead protrudes from the laminate film.

(3) The battery module according to (2), in which a folded section is formed in the laminate film at an outer circumferential section on a side where neither of the positive electrode tab lead and the negative electrode tab lead is protruding, a distance to the electrode stack from the outer circumferential section where the folded section in the laminate film is formed is shorter than a distance to the electrode stack from an outer circumferential section where the sealed section in the laminate film is formed, and adjacent battery cells are disposed such that the sealed section of one adjacent battery cell faces the folded section of the other adjacent battery cell.

(4) The battery module according to any one of (1) to (3), further including: a pair of plate-shaped members that are provided at both ends of the battery cell stack in the stacking direction; and a cushion material that is disposed between at least one of the plate-shaped members and the battery cell stack.

(5) The battery module according to any one of (1) to (4), including a plurality of the battery cell stacks, the plurality of battery cell stacks being electrically connected.

(6) The battery module according to (5), in which, in the plurality of battery cell stacks, a bridge connection is made to the negative electrode tab lead or the positive electrode tab lead that is disposed at one end of each battery cell stack in the stacking direction.

By virtue of the present invention, it is possible to provide a battery module that enables improved energy density while also improving the reliability of connection sections between tab leads of adjacent battery cells and joint sections between tab leads and packaging material even if the battery cells expand and contract accompanying charging and discharging of the battery cells.

### BRIEF DESCRIPTION OF THE DRAWINGS

FIG. 1 is a cross-sectional view that illustrates an example of a battery module according to the present embodiment;

FIG. 2 is a cross-sectional view that illustrates a battery cell from FIG. 1;

FIG. 3 is a cross-sectional view that illustrates a battery cell in which the arrangement of positive electrode tab leads and negative electrode tab leads has been changed;

FIG. 4 is a perspective view that illustrates a laminate film in FIG. 2;

FIG. 5 is a side surface view that illustrates the laminate film in FIG. 2;

FIG. 6 is a partial exploded perspective view of the battery module in FIG. 1; and

FIGS. 7A and 7B are side surface views that illustrate variations of the laminate film in FIG. 2.

### DETAILED DESCRIPTION OF THE INVENTION

With reference to the drawings, a description is given below regarding embodiments of the present invention.

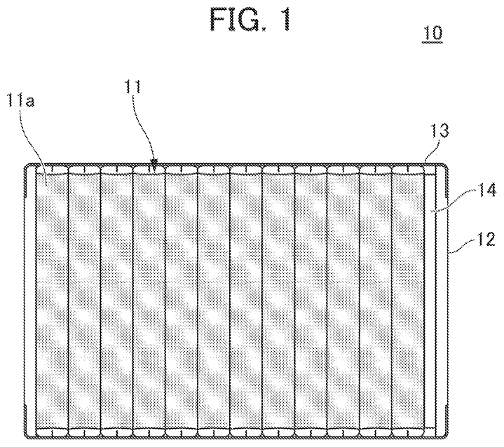

FIG. 1 illustrates an example of a battery module according to the present embodiment.

A battery module 10 is provided with a battery cell stack 11 in which a plurality of battery cells 11a are stacked, end plates 12 that serve as a pair of plate-shaped members provided at both ends of the battery cell stack 11 in the stacking direction, and bind bars 13 that serve as retaining members for retaining the battery cell stack 11 between the pair of end plates 12. Here, the bind bars 13 are mounted at two locations: at an upper section and a lower section in the drawing. In the battery module 10, a cushion material 14 is disposed between the battery cell stack 11 and one of the end plates 12. At this point, because a cushion material is not installed between adjacent battery cells 11a, the energy density of the battery module 10 is improved and a heat dissipation path in the stacking direction of the battery cells 11a is ensured.

Note that the cushion material 14 may be disposed between the battery cell stack 11 and both end plates 12. In addition, a cushion material may be disposed between at least some of the plurality of battery cells 11a. In this case, the thickness of the cushion material is not limited in particular, but is greater than or equal to 0.1 mm and less than or equal to 0.5 mm, for example.

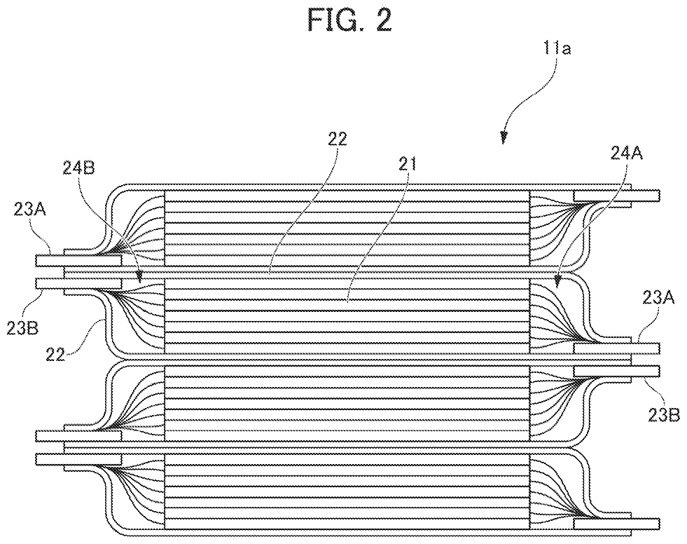

In a battery cell 11a, as indicated in FIG. 2, an electrode stack 21 is packaged in a laminate film 22 serving as a packaging material and has a positive electrode tab lead 23A and a negative electrode tab lead 23B that are protruding from the laminate film 22. Here, the negative electrode tab lead 23B is protruding in the reverse direction to the positive electrode tab lead 23A. In addition, the electrode stack 21 results from stacking a plurality of positive electrodes and a plurality of negative electrodes with an electrolyte interposed therebetween. The electrolyte may be an electrolytic solution or a solid electrolyte, for example, and the electrolytic solution is retained by a separator. The positive electrode tab lead 23A is disposed at one end of the battery cell 11a in the stacking direction of the battery cell 11a, and is connected to the plurality of positive electrodes via positive electrode tabs 24A. The positive electrode tabs 24A are joined to a surface of the positive electrode tab lead 23A that is inside in the stacking direction of the battery cell 11a. In contrast, the negative electrode tab lead 23B is disposed at the other end in the stacking direction of the battery cell 11a, and is connected to the plurality of negative electrodes via negative electrode tabs 24B. The negative electrode tabs 24B are joined to a surface of the negative electrode tab lead 23B that is inside in the stacking direction of the battery cell 11a. At this point, adjacent battery cells 11a are disposed such that the positive electrode tab lead 23A of one adjacent battery cell 11a is close to the negative electrode tab lead 23B of the other adjacent battery cell 11a. At this point, when the battery cells 11a expand and contract accompanying charging and discharging of the battery cells 11a, the battery cell stack 11 as a whole moves in the stacking direction. However, because the positive electrode tab lead 23A and the negative electrode tab lead 23B are disposed at respective ends of the battery cell 11a in the stacking direction, change of the gap between a positive electrode tab lead 23A and a negative electrode tab lead 23B of adjacent battery cells 11a is suppressed. As a result, there is improved reliability of a connection section between the positive electrode tab lead 23A and the negative electrode tab lead 23B of adjacent battery cells 11a, for a joint section between the laminate film 22 and a positive electrode tab lead 23A, and for a joint section between the laminate film 22 and a negative electrode tab lead 23B. At this point, the laminate film 22 is provided with extra length that enables expansion and contraction of the electrode stack 21 to be followed. In addition, a positive electrode tab lead 23A and a negative electrode tab lead 23B that are adjacent are electrically connected via a bus bar, for example.

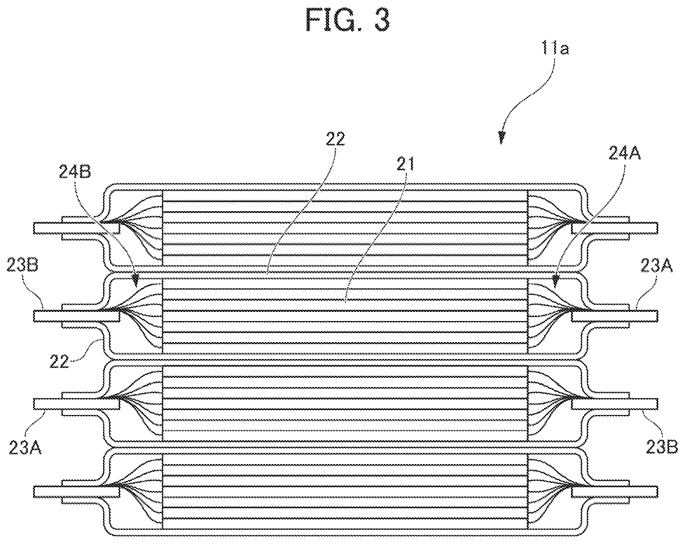

In contrast to this, when the positive electrode tab lead 23A and the negative electrode tab lead 23B are disposed at the center of the battery cell 11a in the stacking direction as illustrated in FIG. 3, the gap between a positive electrode tab lead 23A and a negative electrode tab lead 23B of adjacent battery cells 11a changes in response to expansion and contraction of the battery cells 11a when the battery cells 11a expand and contract accompanying charging and discharging of the battery cells 11a. As a result, there is decreased reliability of a connection section between the positive electrode tab lead 23A and the negative electrode tab lead 23B of adjacent battery cells 11a, for a joint section between the laminate film 22 and a positive electrode tab lead 23A, and for a joint section between the laminate film 22 and a negative electrode tab lead 23B. In this case, when a cushion material is installed between adjacent battery cells 11a, the cushion material expands and contracts, and thus change of the gap between a positive electrode tab lead 23A and a negative electrode tab lead 23B of adjacent battery cells 11a is suppressed.

Note that it may be that adjacent battery cells 11a are disposed such that positive electrode tab leads 23A are close to each other and negative electrode tab leads 23B are close to each other.

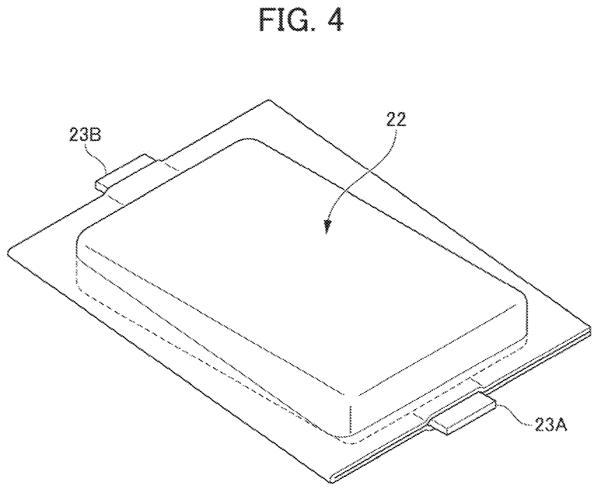

When seen from above in the stacking direction of the battery cells 11a, the laminate film 22 is rectangular, and the positive electrode tab lead 23A and the negative electrode tab lead 23B are protruding from opposing sides of the laminate film 22 by a minimum protrusion allowance required to connect the positive electrode tab lead 23A and the negative electrode tab lead 23B (refer to FIG. 4). Accordingly, the energy density of the battery module 10 is improved.

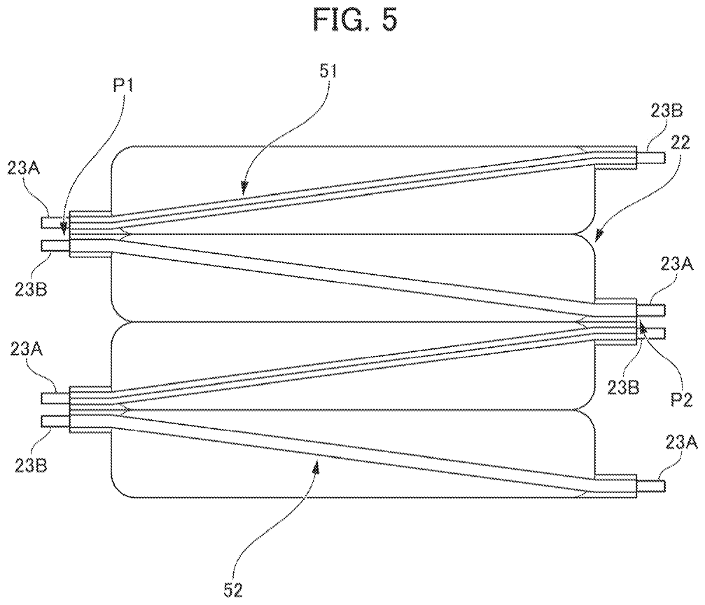

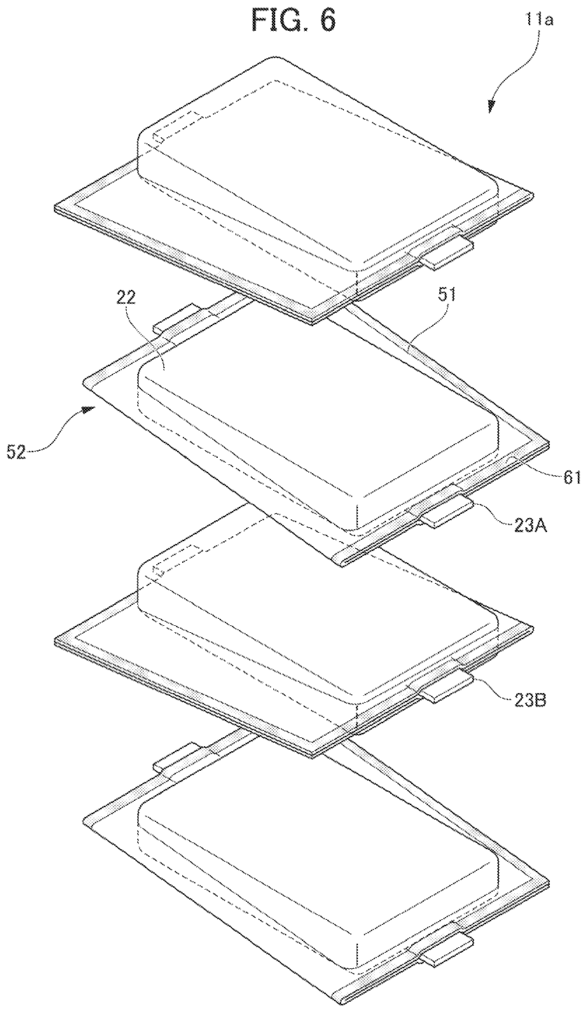

As illustrated in FIG. 5 and FIG. 6, a sealed section 51 is formed at one outer circumferential section of the laminate film 22 on a side where neither of the positive electrode tab lead 23A and the negative electrode tab lead 23B is protruding. Here, the surface of the sealed section 51 has an inclined section that is substantially parallel to a plane formed by a position P1 at which the positive electrode tab lead 23A protrudes from the laminate film 22 and a position P2 at which the negative electrode tab lead 23B protrudes from the laminate film 22. In other words, the inclined section is inclined with respect to the surface of the battery cell 11a. At this point, the angle between the surface of the battery cell 11a and the surface of the inclined section is not limited in particular, but is greater than or equal to 0.5° and less than or equal to 1.0°, for example.

In the present specification and claims, the positions where a positive electrode tab lead and a negative electrode tab lead protrude from a laminate film refer to positions at the centers of the positive electrode tab lead and the negative electrode tab lead in the thickness direction thereof, on portions where the positive electrode tab lead and the negative electrode tab lead protrude from the laminate film.

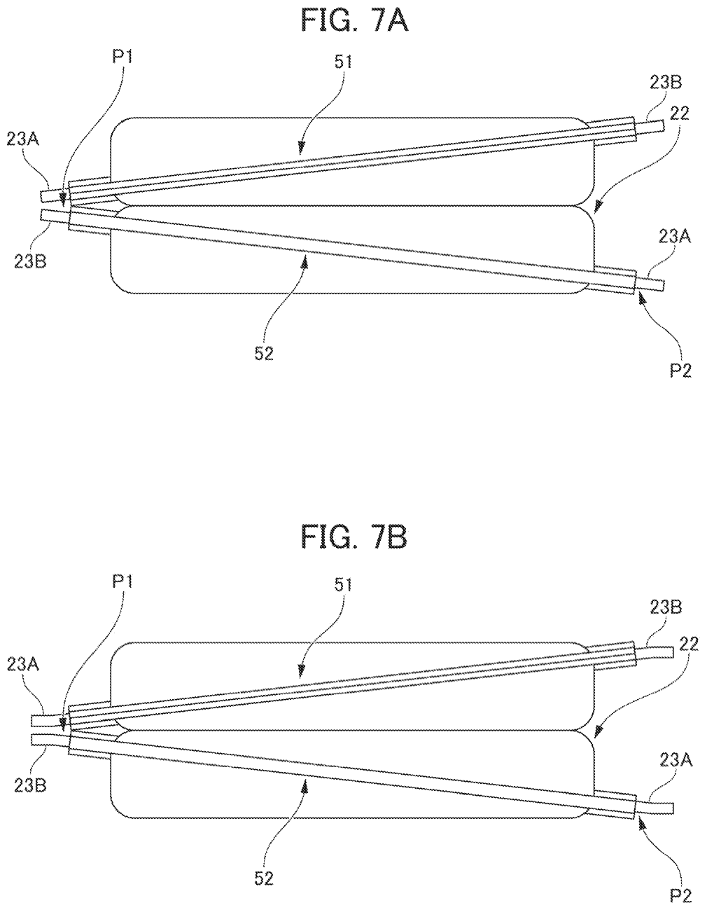

Note that the structure at a position where the positive electrode tab lead 23A or the negative electrode tab lead 23B is protruding from the laminate film 22 may be that illustrated in FIG. 7A or 7B, for example.

As illustrated in FIG. 5 and FIG. 6, a folded section 52 is formed at the other outer circumferential section of the laminate film 22 on a side where neither of the positive electrode tab lead 23A and the negative electrode tab lead 23B is protruding. In addition, a sealed section 61 is formed at an outer circumferential section of the laminate film 22 on a side where the positive electrode tab lead 23A or the negative electrode tab lead 23B is protruding. At this point, the distance to the electrode stack 21 is shorter for the outer circumferential section where the folded section 52 is formed in the laminate film 22 than for the outer circumferential section where the sealed section 51 is formed in the laminate film 22. In addition, adjacent battery cells 11a are disposed such that the sealed section 51 of one adjacent battery cell 11a is facing the folded section 52 of the other adjacent battery cell 11a. Accordingly, a positive electrode tab lead 23A and a negative electrode tab lead 23B are disposed to be nearby in adjacent battery cells 11a, but interference with the folded section 52 is suppressed even if the outer circumferential section where the sealed section 51 is formed is folded back in order to improve the energy density of the battery module 10.

Note that a sealed section may be formed at both outer circumferential sections of the laminate film 22 on sides where neither of the positive electrode tab lead 23A or the negative electrode tab lead 23B is protruding. In addition, it may be that, for example, a tubular laminate film is used, whereby there is no need to form a sealed section at both outer circumferential sections on sides where neither of the positive electrode tab lead 23A and the negative electrode tab lead 23B is protruding.

It may be that a battery module according to the present embodiment is provided with a plurality of battery cell stacks 11, and the plurality of battery cell stacks 11 are electrically connected. At this point, in each battery cell stack 11, similar to the battery module 10, end plates 12 are disposed at both ends of the battery cell stack 11 in the stacking direction thereof, and bind bars 13 that retain the battery cell stacks 11 are disposed between the pair of end plates 12. In addition, a cushion material 14 is disposed between the battery cell stack 11 and one of the end plates 12.

For example, it may be that a plurality of battery cell stacks 11 are disposed so as to be adjacent to each other, and a bridge connection is made to a negative electrode tab lead 23B or a positive electrode tab lead 23A disposed at one end of each battery cell stack 11 in the stacking direction. Even in this case, in each battery cell stack 11, a change in the gap between a positive electrode tab lead 23A and a negative electrode tab lead 23B of adjacent battery cells 11a is suppressed, even if the battery cells 11a expand and contract accompanying charging and discharging of the battery cells 11a. As a result, there is improved reliability of a connection section between the positive electrode tab lead 23A and the negative electrode tab lead 23B of adjacent battery cells 11a, for a joint section between the laminate film 22 and a positive electrode tab lead 23A, and for a joint section between the laminate film 22 and a negative electrode tab lead 23B.

At this point, a positive electrode tab lead 23A or a negative electrode tab lead 23B, which is disposed at an end section on the side in the stacking direction of the battery cell stack 11 at which the cushion material 14 is not disposed, does not move even if the battery cells 11a expand and contract accompanying charging and discharging of the battery cells 11a. Accordingly, it is desirable for a bridge connection to be made for the negative electrode tab lead 23B (or positive electrode tab lead 23A) that is disposed on an end section on the side in the stacking direction of the battery cell stack 11 at which the cushion material 14 is disposed. As a result, the positive electrode tab lead 23A or negative electrode tab lead 23B that does not move is connected to the outside even if the battery cells 11a expand and contract accompanying charging and discharging of the battery cells 11a, and thus the reliability of a connection point with the outside is improved.

The cushion material 14 is not limited in particular so long as the cushion material 14 can absorb the expansion and contraction of the battery cells 11a, and may be a foam body, for example.

The material constituting the foam body is not limited in particular, but may be a polyurethane, a silicone resin, ethylene propylene rubber, a styrene resin, an olefin resin, a polyamide, or a polyester, for example.

The thickness of the foam body is not limited in particular, but is greater than or equal to 1 mm and less than or equal to 2 mm, for example.

For the laminate film 22, a metal layer is formed on a surface of a resin layer, for example. A metal constituting the metal layer is not particularly limited, but may be aluminum, for example. A resin constituting the resin layer may be polyethylene, polyvinyl fluoride, or polyvinylidene chloride, for example.

Each battery cell 11a is not limited in particular, but may be a solid-state battery cell such as an all-solid-state lithium metal battery cell or an all-solid-state lithium-ion battery cell, or a non-aqueous electrolytic solution battery cell such as a lithium metal battery cell, for example. From among these, a solid-state battery cell is desirable.

Description is given below regarding a case where each battery cell 11a is an all-solid-state lithium metal battery cell.

The all-solid-state lithium metal battery cell results from sequentially stacking a positive electrode current collector, a positive electrode mixture layer, a solid electrolyte layer, a lithium metal layer, and a negative electrode current collector, for example.

The positive electrode current collector is not limited in particular, but may be aluminum foil or the like, for example.

The positive electrode mixture layer includes a positive electrode active material, and may also include a solid electrolyte, an electrical conductivity aid, a binder, or the like.

The positive electrode active material is not particularly limited so long as the positive electrode active material can occlude and discharge lithium ions, but may be LiCoO₂, Li(Ni_{5/10}Co_{2/10}Mn_{3/10})O₂, Li(Ni_{6/10}Co_{2/10}Mn_{2/10})O₂, Li(Ni_{8/10}Co_{1/10}Mn_{1/10})O₂, Li(Ni_{0.8}Co_{0.15}Al_{0.05})O₂, Li(Ni_{1/6}Co_{4/6}Mn_{1/6})O₂, Li(Ni_{1/3}Co_{1/3}Mn_{1/3})O₂, LiCoO₄, LiMn₂O₄, LiNiO₂, LiFePO₄, lithium sulfide, or sulfur, for example.

The solid electrolyte constituting the solid electrolyte layer is not limited in particular so long as the solid electrolyte is a material that can conduct lithium ions, but may be, inter alia, an oxide electrolyte or a sulfide electrolyte, for example.

The negative electrode current collector is not limited in particular, but may be copper foil or the like, for example.

Although a description has been provided above for embodiments of the present invention, the present invention is not limited to the embodiments described above, and the embodiments described above may be modified as appropriate within the scope of the gist of the present invention.

### EXPLANATION OF REFERENCE NUMERALS

10 Battery module
11 Battery cell stack
11a Battery cell
12 End plate
13 Bind bar
14 Cushion material
21 Electrode stack
22 Laminate film
23A Positive electrode tab lead
23B Negative electrode tab lead
24A Positive electrode tab
24B Negative electrode tab
51, 61 Sealed section
52 Folded section

What is claimed is:

1. A battery module, comprising:
a battery cell stack in which a plurality of battery cells are stacked,
each of the plurality of battery cells including an electrode stack that is packaged by a packaging material, and having a positive electrode tab lead and a negative electrode tab lead that are protruding from the packaging material,
the negative electrode tab lead protruding in a reverse direction to the positive electrode tab lead,
the electrode stack including a plurality of positive electrodes and a plurality of negative electrodes stacked therein with an electrolyte respectively interposed between the plurality of positive electrodes and the plurality of negative electrodes, wherein
the positive electrode tab lead is disposed at one end of the battery cell in a stacking direction of the battery cell and is connected to the plurality of positive electrodes,
the negative electrode tab lead is disposed at the other end of the battery cell in the stacking direction of the battery cell and is connected to the plurality of negative electrodes, and
adjacent battery cells are disposed such that the positive electrode tab leads are close to each other, the negative electrode tab leads are close to each other, or the positive electrode tab lead of one adjacent battery cell is close to the negative electrode tab lead of the other adjacent battery cell.

2. The battery module according to claim 1, wherein
the packaging material is a laminate film, and a sealed section is formed at least at one outer circumferential section of the packaging material on a side where neither of the positive electrode tab lead and the negative electrode tab lead is protruding, and
a surface of the sealed section has an inclined section that is substantially parallel to a plane formed by a position where the positive electrode tab lead protrudes from the laminate film and a position where the negative electrode tab lead protrudes from the laminate film.

3. The battery module according to claim 2, wherein
a folded section is formed in the laminate film at an outer circumferential section on a side where neither of the positive electrode tab lead and the negative electrode tab lead is protruding,
a distance to the electrode stack from the outer circumferential section where the folded section in the laminate film is formed is shorter than a distance to the electrode stack from an outer circumferential section where the sealed section in the laminate film is formed, and
adjacent battery cells are disposed such that the sealed section of one adjacent battery cell faces the folded section of the other adjacent battery cell.

4. The battery module according to claim 1, further comprising:
a pair of plate-shaped members that are provided at both ends of the battery cell stack in the stacking direction; and
a cushion material that is disposed between at least one of the plate-shaped members and the battery cell stack.

5. The battery module according to claim 1, comprising:
a plurality of the battery cell stacks, wherein
the plurality of battery cell stacks are electrically connected.

6. The battery module according to claim 5, wherein
in the plurality of battery cell stacks, a bridge connection is made to the negative electrode tab lead or the positive electrode tab lead that is disposed at one end of each battery cell stack in the stacking direction.
